(19) United States
(12) Patent Application Publication
(10) Pub. No.: US 2006/0047990 A1
(43) Pub. Date: Mar. 2, 2006

(54) System and method for data storage and transfer between two clock domains

(75) Inventors: Ralph L. James, Andover, MN (US); Douglas A. Larson, Lakeville, MN (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: Micron Technology, Inc.

(21) Appl. No.: 10/933,074

(22) Filed: Sep. 1, 2004

(51) Int. Cl. G06F 1/12

(52) U.S. Cl. 713/400

(57) ABSTRACT

In a memory hub system, several daisy-chained memory hubs are connected to a single memory controller. The memory hub transmitters and receivers operate in a high-speed clock domain, while the logic cores of the memory hubs operate in a low-speed clock domain. A clock domain interface advantageously provides data storage and transfer between the two clock domains without stalling the logic in the low-speed clock domain and without interrupting data movement in the high-speed clock domain.

### BACKGROUND OF THE INVENTION

This invention relates to integrated circuit memory devices. More particularly, this invention relates to a memory hub system wherein a memory controller communicates with several daisy-chained hubs across two different clock domains.

When a memory hub responds to a memory controller request with either read request data or a write request response, that information is typically transmitted to the controller over a high-speed bus. Different elements of the memory hub, however, may operate in a different clock domain (e.g., the memory hub logic may operate at a slower speed than the memory hub transmitters and receivers that interface with the high-speed bus). The data transfer between the memory hubs and the memory controller should be done such that the low-speed memory hub can transmit data onto the high-speed bus without stalling the memory hub or the transmission of data over the high-speed bus. Known systems and methods are often less than adequate at performing such data transfers.

In view of the forgoing, it would be desirable to be able to provide a system and method for data storage and transfer between two clock domains that will not stall or interrupt logic operations in one domain or data movement in another domain.

### SUMMARY OF THE INVENTION

It is an object of this invention to provide data storage and transfer between two clock domains that will not stall logic in a low-speed clock domain while not interrupting data movement in a high-speed clock domain.

In accordance with the invention, a clock domain interface (CDI) provides data storage and transfer between two clock domains.

In a memory hub system, several daisy-chained memory hubs are connected to a single memory controller via a high-speed bus. Memory requests sent by the controller are passed from memory hub to memory hub. Similarly, responses to the memory requests generated by the appropriate memory hub are passed from memory hub to memory hub back to the memory controller. While the memory hub transmitters and receivers operate in a high-speed clock domain to receive and transmit data along the high-speed bus, the logic cores of the memory hubs typically operate in a low-speed clock domain. The CDI controls data storage and transfer between the two clock domains by multiplexing and de-multiplexing data such that substantially the same data rate is provided in both clock domains. That is, larger amounts of data may be provided per clock cycle in the low speed clock domain, while smaller amounts of data may be accessed at faster speeds in the high-speed domain. For example, in the low-speed clock domain, data may be transmitted in 256 bit words at a low-speed clock rate of 400 MHz, while that data may be transmitted in 64 bit words at a high-speed clock rate of 1.6 GHz. Both of these data transmission schemes have the same overall data rate.

The CDI advantageously allows data storage and transfer between two clock domains without stalling the logic in the low-speed clock domain and without interrupting the data movement in the high-speed clock domain.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a diagram of a memory hub system in accordance with the invention;

FIG. 2 is a diagram of a memory hub system in greater detail in accordance with the invention;

FIG. 3 is a diagram of a memory hub in accordance with the invention;

FIG. 4 is a diagram of a clock domain interface in accordance with the invention; and

FIG. 5 is a block diagram of a system that incorporates the invention.

### DETAILED DESCRIPTION OF THE INVENTION

The invention provides a system and method for data storage and transfer between two clock domains of preferably a memory hub system. A memory controller sends memory requests to several daisy-chained hubs across a high-speed bus and receives corresponding responses from those memory hubs across the same or another high-speed bus. A clock domain interface (CDI) transfers data to high-speed transmitters from low-speed core memory logic without stalling or interrupting data movement across the high-speed bus.

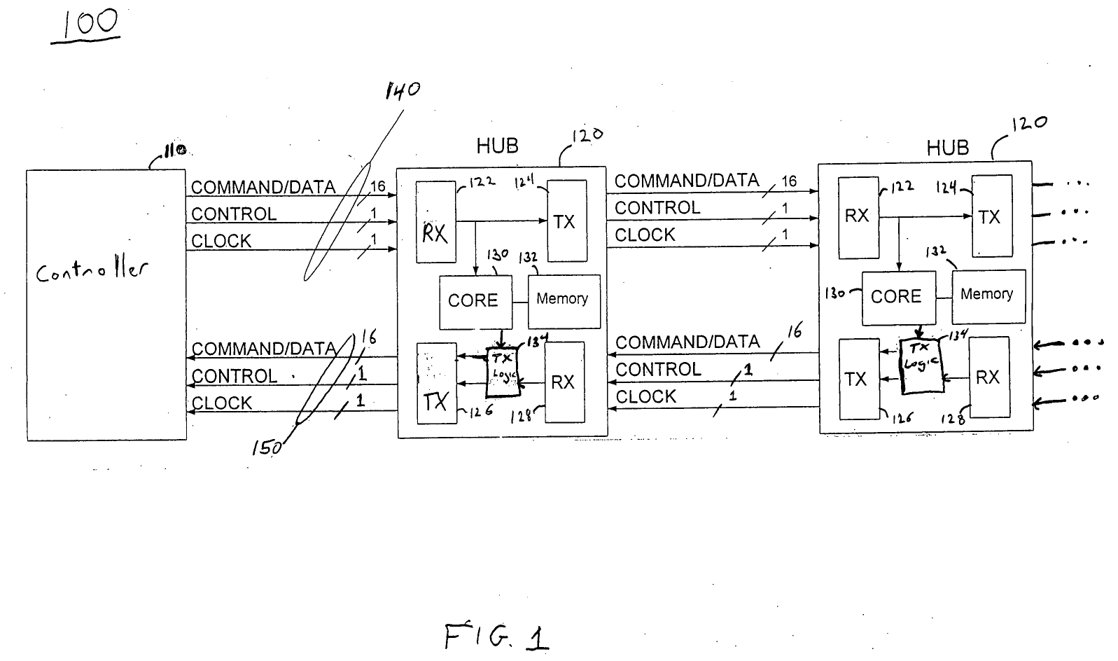

FIG. 1 shows memory hub system 100 in accordance with the invention. Memory controller 110 sends memory requests to several daisy chained memory hubs 120 across downstream high-speed bus 140 and receives responses back from memory hubs 120 over upstream high-speed bus 150. High-speed buses 140 and 150, for example, may have 16 command and data lines, a control line, and a clock line.

When memory controller 110 sends a memory request to memory hubs 120, the request is received by each memory hub 120 using downstream receiver 122 and is transmitted to the next memory hub 120 using downstream transmitter 124. Memory request responses are similarly passed back to memory controller 110 by memory hubs 120 using upstream receiver 128, transmitter logic 134, and upstream transmitter 126.

Within each memory hub 120, the memory request is also received by core logic 130. Core logic 130, if it has the portion of memory specified by a memory request, forwards the memory request to its local memory 132. Local memory 132 and core logic 130 respond to the memory request with the data requested by a data read command or with a response to a data write command. The response is transferred by transmitter logic 134 to the upstream transmitter 126 for transmission over high-speed bus 150 back to memory controller 110. The data transfer from memory hubs 120 to upstream high-speed bus 150 is advantageously done such that (1) core logic 130 is not stalled, (2) handshaking across clock domains does not stall data movement, and (3) other data transmitted over high-speed bus 150 is not interrupted.

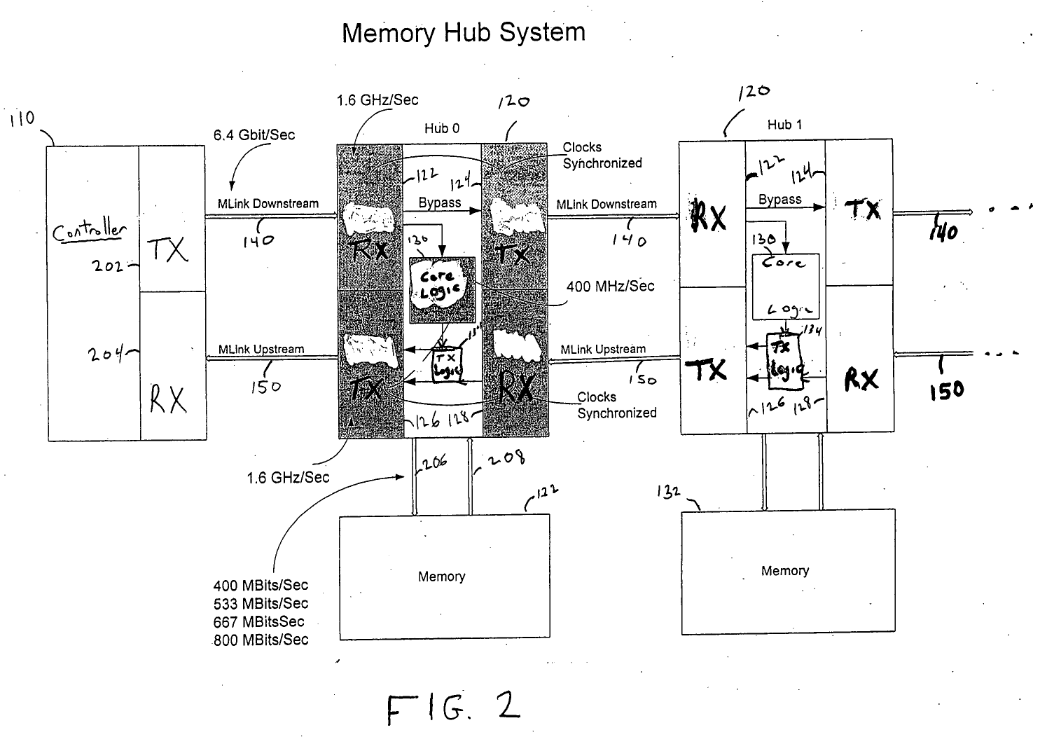

FIG. 2 shows a more detailed embodiment of memory hub system 100. As in FIG. 1, FIG. 2 shows memory controller 110, high-speed bus 140, memory hubs 120, and high-speed bus 150. As previously described, each memory hub 120 operates with two distinct clock domains: a high-speed clock domain and a low-speed clock domain. Memory hub transmitters 124 and 126 and memory hub receivers 122 and 128 operate in the high-speed domain and memory hub core logic operates in the low-speed domain.

For illustrative purposes, assume that the high-speed clock domain operates at a speed of 1.6 GHz and the low-speed clock domain operates at 400 MHz. The high-speed clock domain is thus four times the speed of the low-speed clock domain. (Note that in the present embodiment high-speed and low-speed clock domains may operate at different speeds, as long as the ratio between the clock domains is maintained.)

Also assume for illustrative purposes that high-speed buses 140 and 150 each transmit a clock source signal received by memory hub receivers 122 and 128 that may be used to generate local low-speed and high-speed clocks within each memory hub 120. More particularly, in the downstream direction, each downstream receiver 122 may generate a local high-speed clock from the clock source signal to facilitate receipt of data from high-speed bus 140. In the upstream direction, each upstream receiver 128 may generate a local high-speed clock to facilitate receipt of data from high-speed bus 150. Each upstream receiver 128 may also generate a low-speed clock for core logic 130.

After generating a high-speed clock, each downstream receiver 122 passes the generated clock to its counterpart downstream transmitter 124 of the same memory hub 120. Thus, the downstream receiver 122 and transmitter 124 in each hub 120 use the same clock signal and are synchronous.

Downstream transmitter 124 uses the passed clock signal to move the data received over high-speed bus 140 farther downstream to the next memory hub 120. The clock source signal is also sent by downstream transmitter 124 to the next downstream receiver 122 over high-speed bus 140.

In the upstream direction, the upstream transmitter 126 in the memory hub 120 farthest downstream sends a clock source signal to the next upstream hub 120. The upstream receiver 128 of the second hub 120 generates a high-speed clock from the clock source to capture the incoming data. The generated high-speed clock is sent to counterpart upstream transmitter 126. Upstream transmitter 126 also preferably generates a low-speed clock which is sent to core logic 130. A clock source signal is also sent by upstream transmitter 126 to the next upstream receiver 128 over high-speed bus 150. In the upstream direction, clock signals for upstream receiver 128, transmitter 126, and core logic 130 are all derived from the same clock source signal and are thus all synchronous.

Note that in this embodiment, even though all receivers and transmitters in memory hubs 120 operate in the high-speed clock domain, downstream receivers 122 and transmitters 124 are not synchronous with upstream receivers 128 and transmitters 126. Their clock signals are derived from different clock source signals.

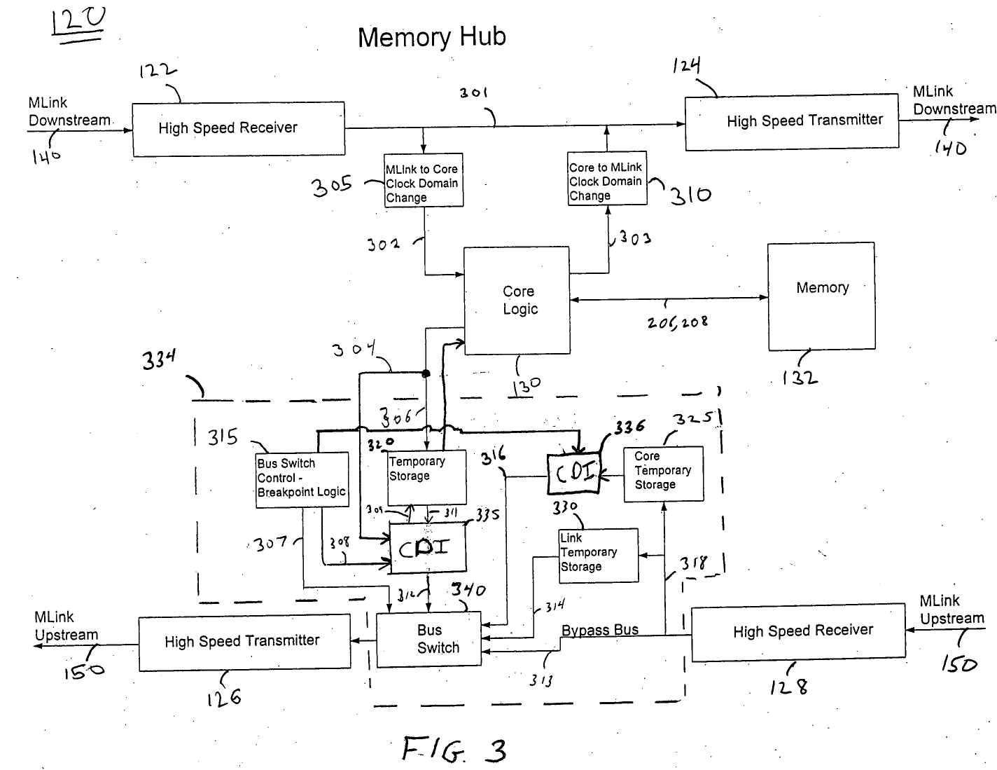

FIG. 3 is a more detailed embodiment of memory hub 120 that shows the high speed bus network and core logic interconnections. Downstream memory requests are transmitted over high-speed bus 140 and enter memory hub 120 through downstream receiver 122 (this FIG. focuses on the data path of memory hub system 100 and thus the control and clock lines of high-speed buses 140 and 150 have been omitted for clarity). Memory requests propagate over line 301 from downstream receiver 122 to downstream transmitter 124 for transmission over downstream high-speed bus 140 to the next downstream memory hub 120. Downstream receiver 122 and downstream transmitter 124 operate at the same synchronous clock frequency, so memory requests can be moved directly.

In an example of this embodiment, high-speed buses 140 and 150 carry data over sixteen data lines at a rate of 6.4 gigabits per second. When the data stream of high-speed bus 140 is received by downstream receiver 122, the data are preferably multiplexed to avoid interruptions in the downstream data flow. For example, the 6.4 gigabit per second data stream transmitted over 16 lines in high-speed bus 140 may be multiplexed over 64 data lines by downstream receiver 122. With 64 data lines operating at 1.6 GHz, downstream receiver 122 can output data at the same rate as high-speed bus 140.

Each memory request is sent to core logic 130 after it is received by downstream receiver 122. The memory request cannot be sent directly from downstream receiver 122 to core logic 130, because downstream receiver 122 and core logic 130 operate at different clock frequencies and are not synchronous. Thus, clock domain changer 305, which may be, for example, a buffer, a first-in-first-out (FIFO) queue, other queue, or other suitable temporary storage device, is used to receive data from downstream receiver 122 and to forward that data to core logic 130 independent of the two non-synchronous clocks. Furthermore, if, for example, downstream receiver 122 operates at a 1.6 GHz clock speed and memory core 130 operates at a 400 MHz clock speed, clock domain changer 305 may further multiplex the data signal to maintain the same data rate in the low-speed clock domain. For example, clock domain changer 305 may multiplex the data signal from 64 data lines to 256 data lines to maintain the same data rate at the low-speed clock domain. Clock domain changer 310 may be used similarly to send data from memory core 130 back onto the downstream path.

Memory core logic 130 passes all relevant memory requests to local memory 132. Memory core logic 130 and local memory 132 are preferably synchronous; however, local memory may be operated at a different clock speed. Accordingly, memory core logic may multiplex, de-multiplex, or use other suitable techniques to transmit and receive data to and from local memory 132.

When a memory read request is received by memory core logic 130, a read response is formulated along with the read data for transmission to memory controller 110. When a memory write request is received by memory core logic 130, a write response is formulated for transmission to memory controller 110 via upstream transmitter 126.

Upstream transmitter 126 takes data from several sources and merges it onto upstream high-speed bus 150. In particular, upstream transmitter 126 merges the data to be transmitted from memory core logic 130 with the incoming data on upstream high-speed bus 150.

In order to perform this task, bus switch 340, controlled by bus switch control logic 315, switches between bypass bus 313, temporary storage buffers 325 and 330, and clock domain interface (CDI) 335, which converts the low-speed clock domain output of core logic 130 to the high-speed clock domain.

Upstream receiver 128 receives data over high-speed bus 150. When memory core logic 130 has no data to be transmitted upstream to memory controller 110, the received data is sent directly to upstream transmitter 126 via bypass bus 313. As in the downstream direction, the data may be sent directly because upstream receiver 128 and transmitter 126 are synchronous.

However, whenever data from core logic 130 is transmitted by upstream transmitter 126, the upstream data provided by receiver 128 is placed in a temporary storage buffer for the duration of the core logic data transmission. In this embodiment, two temporary storage buffers are used: link temporary storage 330 and core temporary storage 325. Link temporary storage 330 stores and re-transmits data at the same clock rate as upstream receiver 128 and upstream receiver transmitter 126 (e.g., 1.6 GHz). Link temporary storage 330 can be used for temporary storage of data because it operates in the high-speed domain, even though it can only store a small amount of data. For temporary storage of larger amounts of data, core temporary storage 325 can be used. Core temporary storage 325 stores data at the slow-speed of core logic 130 (e.g., 400 MHz). At this slower speed, more data can be stored.

Clock domain interface (CDI) 335 is the control and handshaking interface between the low-speed and high-speed clock domains. Core logic 130 sends data to be transmitted to memory controller 110 to CDI 335 via data buses 304 and 306. When CDI 335 is empty, data can be sent directly from core logic 130 via data bus 304. When CDI is full, data from core logic 130 is stored in temporary storage until space is available and then sent to CDI 335 via data bus 311. Breakpoint logic 315 controls the operation of CDI 335 and coordinates the transmittal of CDI data through bus switch 340 into upstream transmitter 126.

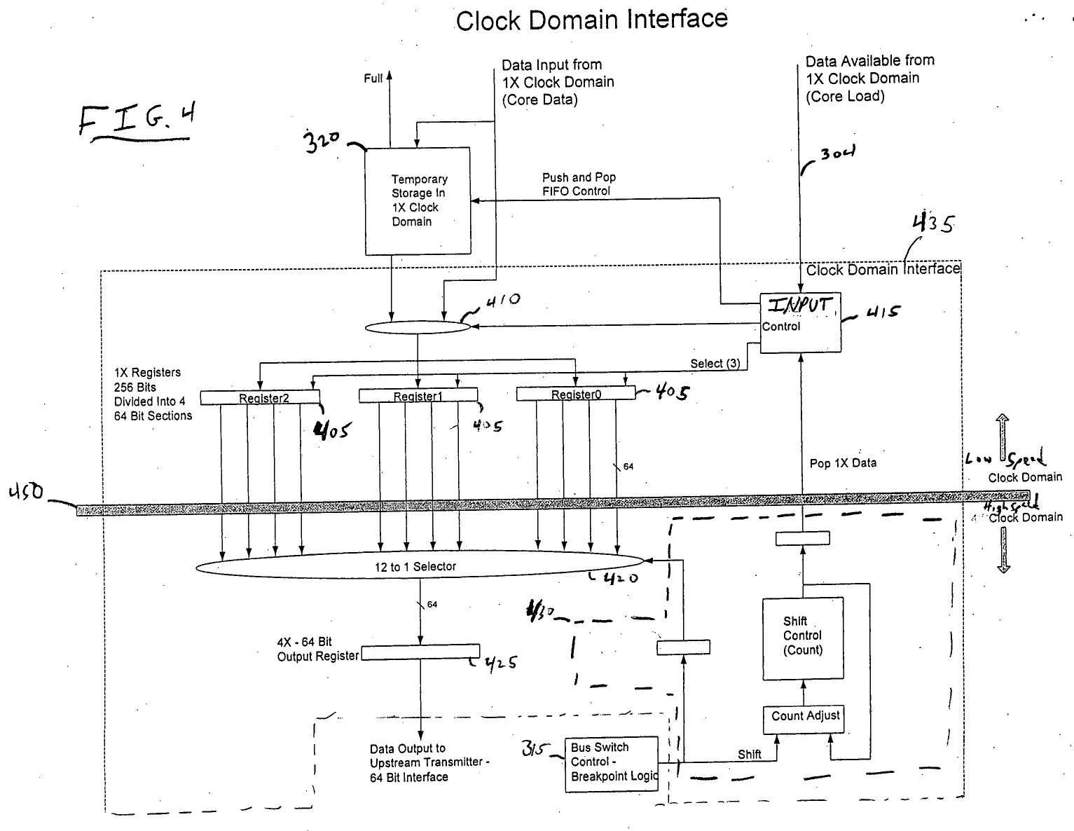

FIG. 4 illustrates an embodiment of CDI 335 in greater detail in accordance with the invention. CDI 435 contains three data registers 405, input multiplexer 410, input control 415, output multiplexer 420, output register 425, and output control 430. Low-speed clock domain circuit elements are shown above illustrative boundary line 450 (not a part of CDI 435), and high-speed clock domain circuit elements are shown below line 450.

When core logic 130 has data to be transmitted upstream to memory controller 110, it activates a core load signal on signal line 304. Data is loaded into any empty registers 405, one at a time, with any remaining data loaded into temporary storage 320. If temporary storage 320 is filled up, CDI 435 may signal core logic 130 to stop sending data until there is more space available in registers 405 and temporary storage 320.

In one example according to the invention, data from core logic 130 is sent in a 256 data line bus. Registers 405 each receive and store a single 256 bit word. Registers 405 can output each 256 bit word as four separate 64 bit words. As indicated by illustrative boundary line 450, data is received by registers 405 in the low-speed clock domain, but output from registers 405 in the high-speed clock domain.

When breakpoint logic 315 selects CDI 435 to output data to upstream transmitter 126, it sends control signals to output control 430. Output control 430 uses counters and control signals to select one 64 bit word from registers 405 for each high-speed clock cycle. Beginning at first register 405, four 64 bit words are removed, emptying the 256 bit register. As subsequent registers 405 are emptied, the empty registers 405 are refilled with any remaining data from temporary storage 320 and core logic 130.

Output logic 430 coordinates filling and emptying of registers 405 by controlling output multiplexer 420 to cycle through the outputs of registers 405. Output logic 430 also sends a control signal to input control 415 to coordinate the filling of empty registers 405. Input control 415 controls input multiplexer 410 to select temporary storage 320 or memory core 130 as the data source and to select the register 405 in which to load the data.

CDI 435 allows any number of 64 bit words to be removed from registers 405, which are filled in the low-speed clock domain. Upstream transmitter 126 may receive a certain number of data words from logic core 130, then switch to another data source (e.g., received upstream data), and return to data from logic core 130. All of this may be done in the high-speed clock domain and the two data sources may be seamlessly interleaved.

The low-speed clock domain is not affected by or dependent on the high-speed clock domain. As long as registers 405 and temporary storage 320 are not full, logic core 130 provides data to CDI 435 in the low-speed clock domain, and CDI 435 outputs that data in the high-speed clock domain. Thus, the task of supplying data from the low-speed domain and extracting it to the high-speed domain is advantageously accomplished with little high-speed logic. The data stream of core logic 130 will not be interrupted and the data supplied to the high-speed clock domain will not have to stall because of handshaking between the two clock domains. Further, less required logic in the high-speed clock domain advantageously permits larger temporary storage in the low-speed clock domain and has less stringent timing requirements.

Returning to FIG. 3, a second CDI 336 may be provided at the output of core temporary storage 325. CDI 336 may operate in a similar manner as CDI 335. As previously described, core temporary storage 325 stores data at the slow-speed of core logic 130 (i.e., 400 MHz). Thus, before the data stored in core temporary storage 325 can be re-transmitted through bus switch 340 to high-speed transmitter 126, CDI 336 provides the control and handshaking interface between the low-speed and high-speed clock domains.

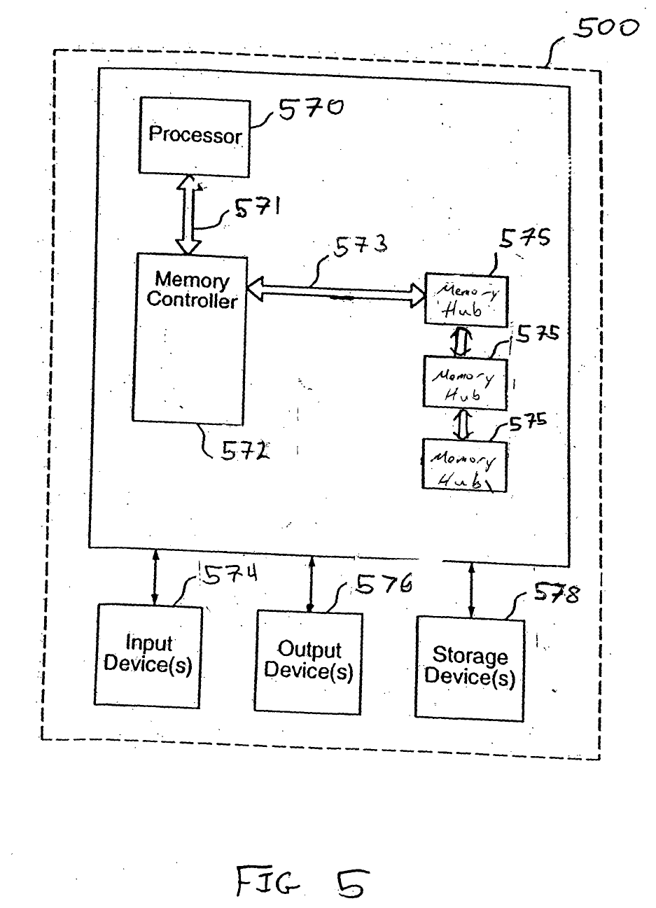

FIG. 5 shows a system that incorporates the invention. System 500 includes a plurality of memory hubs 575, a processor 570, a memory controller 572, input device(s) 574, output device(s) 576, and optional storage device(s) 578. Data and control signals are transferred between processor 570 and memory controller 572 via bus 571. Similarly, data and control signals are transferred between memory controller 572 and memory hubs 575 via high-speed bus 573. One or more memory hubs 575 include clock domain interface (CDI) circuits in accordance with the invention. The CDI circuits improve performance by providing efficient data storage and transfer between two clock domains, such as the low-speed clock domain internal to memory hub 575 and the high-speed clock domain of high-speed bus 573. Input device(s) 574 can include, for example, a keyboard, a mouse, a touch-pad display screen, or any other appropriate device that allows a user to enter information into system 500. Output device(s) 576 can include, for example, a video display unit, a printer, or any other appropriate device capable of providing output data to a user. Note that input device(s) 574 and output device(s) 576 can alternatively be a single input/output device. Storage device(s) 578 can include, for example, one or more disk or tape drives.

Thus it is seen that systems and methods for storage and transfer of data between two clock domains is provided that does not stall or interrupt logic or data movement in either respective clock domain. One skilled in the art will appreciate that the invention can be practiced by other than the described embodiments, which are presented for purposes of illustration and not of limitation, and the present invention is limited only by the claims which follow. For example, although the memory hub system is primarily depicted and described herein as having a high-speed clock domain that is four times the speed of the low-clock domain, it will be understood that the design of the memory hub system may be modified to have a different ratio between the two clock domains (e.g., the high-speed clock domain may be twice to ten times the speed of the low-speed clock domain).

We claim:

1. A method of transferring data between a first clock domain and a second clock domain different than said first domain, said method comprising:
receiving data;
dividing said data into first data words of a first word length;
storing at least one of said first data words in a single cycle of a first clock in said first clock domain;
dividing said at least one of said first data words into second data words each of a second word length; and
retrieving said second data words each in a single cycle of a second clock in said second is clock domain.

2. The method of claim 1 wherein the ratio of the speed of said second clock domain to the speed of said first clock domain ranges from about 2 to about 10.

3. The method of claim 1 wherein the ratio of the speed of said second clock domain to the speed of said first clock domain is about 4.

4. The method of claim 1 wherein the ratio of the speed of said first clock domain to the speed of said second clock domain is substantially equal to the ratio of said second word length to said first word length.

5. The method of claim 1 further comprising inserting said second data words into a data stream operating in said second clock domain.

6. A method of transferring data between a first clock domain and a second clock domain different than said first domain, said method comprising:
transmitting a request to a plurality of circuits in said first clock domain;
receiving said request in at least one of said circuits in said first clock domain;
transferring said request to said second clock domain;
processing said request in said second clock domain;
generating a response in said second clock domain as a result of said processing;
storing said response as data words of a first size in said second clock domain; and
retrieving said stored data words as data words of a second size in said first clock domain, the ratio of the speed of said first clock domain to the speed of said second clock domain being substantially equal to the ratio of said first word size to said second word size.

7. The method of claim 6 wherein the speed of said first clock domain is higher than the speed of said second clock domain.

8. The method of claim 6 wherein the ratio of the speed of said first clock domain to the speed said second clock domain is about 4.

9. The method of claim 6 further comprising transmitting said retrieved data words in said first clock domain.

10. An interface circuit for transferring data between a first clock domain and a second clock domain different than said first domain, said circuit comprising:
a first register operative to receive a first unit of data within one clock cycle of said first clock domain, said register having a plurality of outputs each operative to output an equal portion of said first unit of data; and
a second register operative to receive one of said portions of said first unit of data from said first register within one clock cycle of said second clock domain; wherein:
the ratio of the speed of said first clock domain to the speed of said second clock domain is substantially the same as the ratio of the size of said portion of said second unit of data to the size of said first unit of data.

11. The interface circuit of claim 10 wherein said first and said second registers comprise a memory hub.

12. The interface circuit of claim 10 further comprising a multiplexer coupled between said first and said second registers.

13. An interface circuit for transferring data between a first clock domain and a second clock domain different than said first domain, said circuit comprising:
a plurality of registers, each register operative to receive data words of a first word length within one clock cycle of said first clock domain, each of said plurality of registers having a plurality of outputs each operative to output a respective equal portion of said data words of a first word length as data words of a second word length;
an input controller operative to cyclically activate each of said plurality of registers to receive said data words of a first word length, wherein said controller cycles through said plurality of registers in said first clock domain; and
an output controller operative to cyclically read each of said plurality of outputs from said active register to output said data words of a first word length as data words of a second word length, wherein said controller cycles through said plurality registers in said second clock domain.

14. The interface circuit of claim 13 wherein the first word length is about 4 times longer than the second word length.

15. The interface circuit of claim 13 wherein the speed of said second clock domain is about 4 times faster than the speed of said first clock domain.

16. The interface circuit of claim 13 wherein the ratio of the speed of said first clock domain to the speed of said second clock domain is substantially equal to the ratio of said second word length to said first word length.

17. Apparatus for transferring data between a first clock domain and a second clock domain different than said first domain, said apparatus comprising:
means for receiving data;
means for dividing said data into first data words of a first word length;
means for storing at least one of said first data words in a single cycle of a first clock in said first clock domain;
means for dividing said at least one of said first data words into second data words each of a second word length; and
means for retrieving said second data words each in a single cycle of a second clock in said second clock domain.

18. The apparatus of claim 17 wherein the ratio of the speed of said second clock domain to the speed of said first clock domain ranges from about 2 to about 10.

19. The apparatus of claim 17 wherein the ratio of the speed of said first clock domain to the speed of said second clock domain is substantially equal to the ratio of said second word length to said first word length.

20. The apparatus of claim 17 further comprising means for inserting said second data words into a data stream operating in said second clock domain.

21. Apparatus for transferring data between a first clock domain and a second clock domain different than said first domain, said apparatus comprising:
means for transmitting a request to a plurality of circuits in said first clock domain;
means for receiving said request in at least one of said circuits in said first clock domain;
means for transferring said request to said second clock domain;
means for processing said request in said second clock domain;
means for generating a response to said processing in said second clock domain;
means for storing said response as data words of a first size in said second clock domain; and
means for retrieving said stored data words as data words of a second size in said first clock domain, wherein the ratio of the speed of said first clock domain to the speed of said second clock domain is substantially equal to the ratio of said first word size to said second word size.

22. The apparatus of claim 21 wherein the ratio of the speed of said first clock domain to the speed of said second clock domain ranges from about 2 to about 10.

23. The apparatus of claim 22 further comprising means for transmitting said retrieved data words in said first clock domain.

24. A system comprising:
a memory controller;
a high speed bus operating in a first clock domain coupled to said controller; and
a plurality of memory hubs operating in a second clock domain serially coupled to said high-speed bus, said memory hubs comprising:
a receiver operative to receive requests in said first clock domain from said memory controller over said high-speed bus;
a memory;
a control logic operative to retrieve data from said memory in said second clock domain, said control logic comprising:
a first register operative to receive a first unit of data from said memory within one clock cycle of said second clock domain, said register having a plurality of outputs each operative to output a respective equal portion of said first unit of data;
a second register operative to receive one of said portions of said first unit of data from said first register within one clock cycle of said first clock domain; and
a transmitter operative to transmit said portion of said first unit of data to said controller over said high-speed bus in said first clock domain.
